(19) United States
(12) Patent Application Publication
(10) Pub. No.: US 2001/0024733 A1
(43) Pub. Date: Sep. 27, 2001

(54) Insert for a radiant tube

(76) Inventor: Martin R. Kasprzyk, Ransomville, NY (US)

Correspondence Address: Howard J. Greenwald, Suite 2490, 349 West Commercial Street, East Rochester, NY, 14445, US

(21) Appl. No.: 09/776,110

(22) Filed: Feb. 2, 2001

Related U.S. Application Data
(63) Continuation-in-part of application No. 09/658,143, filed on Sep. 8, 2000.
(60) Provisional application No. 60/153,306, filed on Sep. 10, 1999.

(51) Int. Cl. F16L 1/00

(52) U.S. Cl. 428/592; 428/36.9; 428/371; 138/38

(57) ABSTRACT

An insert for a radiant tube comprised of an oxidation resistant metal alloy or a refractory material. The insert has a helical shape and a helix angle of from about 50 to about 80 degrees

### CROSS-REFERENCE TO RELATED PATENT APPLICATION

This patent application is a continuation-in-part of applicant's copending patent application U.S. Ser. No. 09/658,143, filed on Sep. 8, 2000.

### FIELD OF THE INVENTION

An insert for a radiant tube comprised of an oxidation resistant and creep resistant metal alloy or a refractory material, said insert having a helical shape and a helix angle of from about 30 to about 80 degrees.

### BACKGROUND ART

Many industrial process furnaces require special atmospheres and, thus, cannot be directly heated by means of gas combustion. These special atmosphere furnaces are often heated by means of a system in which gas-air combustion takes place within long metal alloy tubes which exit to the outside of the furnace wall to prevent contamination of the flrnace's atmosphere. These furnaces are primarily heated by radiation coming off of the tubes; thus these tubes are called “radiant tubes.”

Such “radiant tubes” are well known to those skilled in the art and are described, e.g., in applicant's U.S. Pat. Nos. 5,655,599, 5,071,685, and 4,789,506. The tubes sometimes contain “inserts” to increase heat transfer from the combustion gases to the inside surface of the radiant tube. Thus, e.g., U.S. Pat. No. 4,869,230 of John Fletcher describes a “turbulator insert” in a radiant tube which is formed as a corrugated strip of metal alloy material twisted to form a helix. According to the Fletcher patent, “Typically the strip 52 is twisted to a pitch of from 250 to 350 mm using 70 mm wide strip.”

Such metal alloy material inserts are not very effective in transferring heat. It is thus an object of this invention to provide a metal alloy material insert which is substantially more effective than the metal alloy inserts described in the Fletcher patent.

### SUMMARY OF THE INVENTION

In accordance with this invention, there is provided an insert for a radiant tube comprised of an oxidation resistant metal alloy or a refractory material, said insert having a helical shape and a helix angle of from about 30 to about 80 degrees.

### BRIEF DESCRIPTION OF THE DRAWINGS

The claimed invention will be described by reference to the following drawings, in which like numerals refer to like elements, and in which:

FIG. 1 is a sectional view of a radiant tube assembly;

FIG. 2 is a side view of one preferred insert of the invention;

FIG. 3 is a schematic view of several suitable insert cross-sections;

FIG. 4 is a schematic representation of a novel radiant tube assembly;

FIGS. 5 and 6 are schematics of one preferred means for making the inserts of the invention; and

FIG. 7 is a flow diagram of a preferred process for making a cast insert.

### DESCRIPTION OF THE PREFERRED EMBODIMENTS

In the first part of this specification, applicant will describe a process for making a ceramic insert. In the second part of this application, applicant will be describe a process for making a metal alloy insert. In the third part of this application, applicant will describe a process for making a castable refractory insert. The ceramic insert of the invention

The insert of this invention is made from a ceramic material which has resistance to thermal shock. In general, such material will have a combination of low thermal expansion rate and high thermal conductivity properties.

As used herein, the term “ceramic” includes an inorganic material (such as silicon nitride, silicon carbide), used either by itself or with an infiltrant. Thus, as used in this specification, a body consisting essentially of silicon carbide is “ceramic.” Additionally, a body which consists of a porous silicon carbide body infiltrated with infiltrant such as molten silicon, also is “ceramic.” Additionally, a mixture of silicon carbide particles and either graphite and/or amorphous carbon particles may be used to prepare a “ceramic.” It is preferred that at least about 40 volume percent of the final material be comprised of either silicon carbide, silicon nitride, silicon, and/or mixtures thereof.

The thermal expansion rate of the ceramic material generally is less than 6.0×10⁻⁶ meter/meter/degree Celsius and, preferably, less than 4.5×10⁻⁶ meter/meter/degree Celsius.

The thermal conductivity of the ceramic material varies with temperature. At a temperature of 25 degrees Celsius, the thermal conductivity of the ceramic material is at least about 0.2 (and preferably at least about 0.3) calories/centimeter/second/degree Celsius. At a temperature of 1,200 degrees Celsius, the thermal conductivity of the ceramic material is at least about 0.05 (and preferably at least about 0.08) calories/centimeter/second/degree Celsius.

The ceramic material preferably is substantially oxidation resistant in the combustion flame environment. The ceramic material preferably is also creep resistant. When the material is heated to a temperature of at least about 1,400 degrees Celsius for at least about 5 years, it will not change its shape under its own weight.

In one preferred embodiment, the ceramic material is silicon carbide. In another preferred embodiment, the ceramic material is silicon nitride.

One may also use mixtures of ceramic materials which provide the required properties. Thus, e.g., one may use one or more of the materials disclosed in U.S. Pat. No. 5,523,133. Thus, one may use materials comprised of a silicon carbide matrix with ceramic oxide fiber reinforcements.

The ceramic insert may be comprised of a plurality of strips, each twisted longitudinally to define between its opposite end portions helical passages on opposite sides of each strip, wherein each of said strips are of a substantially uniform width; see, e.g., U.S. Pat. No. 5,523,133.

By way of further illustration, the ceramic insert of this invention may be a three-, four-, and/or six-leaf radiating surface tube insert, as is disclosed in U.S. Pat. No. 3,886,976 of Kardas et al. In one aspect of this embodiment, the insert is the in the shape of a five-leaf cruciform; see, e.g., U.S. Pat. No. 2,895,508 of Drake. In another aspect of this embodiment, the insert may be in the shape of a spiral cruciform with notched edges; see, e.g., U.S. Pat. No. 3,394,736 of Pearson.

In one embodiment, the ceramic insert has a cross sectional shape defined by a lateral portion inclined at right angles with respect to and on either side of a central portion. In another embodiment, the ceramic insert has a cross-sectional shape defined by lateral portions having a profile which is curved inwardly toward a plane N that is normal to the center portion. In yet another embodiment, the ceramic insert has a cross sectional shape defined by a central portion having double S-shaped curvature. These shapes are disclosed on page 104 of Topical Technical Report GRI 91-0146, published June, 1991 by the Gas Research Institute of Chicago, Ill.; and they are also disclosed in U.S. Pat. No. 4,700,749.

The ceramic insert may be in the shape of a swirl flow device, such as one or more of the swirl flow devices disclosed in U.S. Pat. Nos. 1,770,208, 1,916,337, 2,097,104, 2,161,887, 3,071,159, 3,407,871, 3,783,938, 3,870,081, 4,044,796, 4,090,559, 4,336,883, 4,559,998, 4,700,749, 4,823,865, and the like.

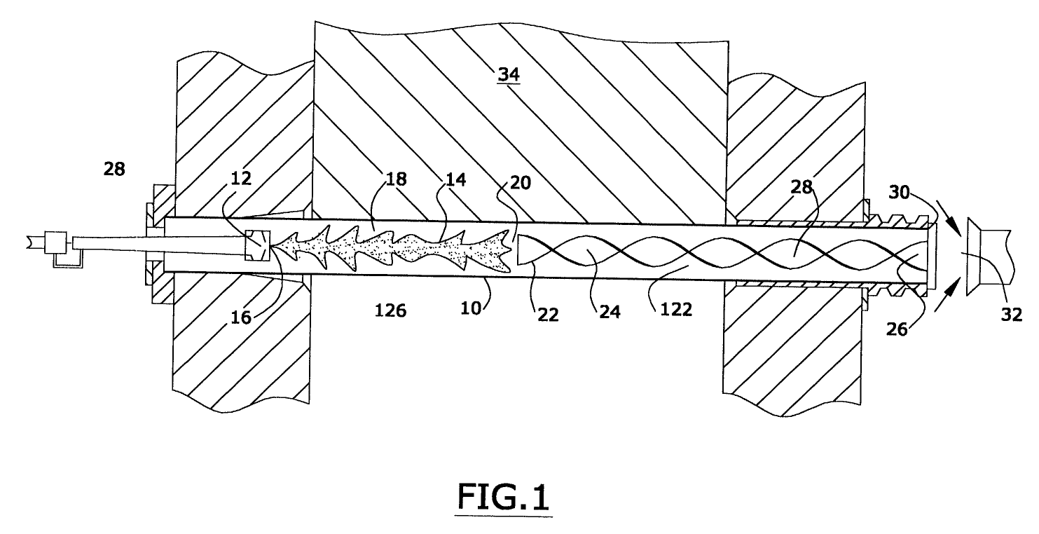

FIG. 1 is a schematic representation of a radiant tube 10. Air and gas are fed into such tube through burner tip 12, creating an area of advancing flame 14. As the combustion process, continues, the mixture within tube 10 changes. Thus, at point 16, the mixture within tube 10 primarily contains gas and air. At point 18, the mixture within tube 10 contains gas, air, and combustion products. At point 20, combustion is complete, and normally all of the fuel has been consumed. As will be apparent, the temperature at points 16, 18, and 20 will differ.

At point 22, the mixture within tube 10 first contacts helical ceramic insert 24, and it exchanges heat with such insert. The temperature at point 22 will differ from the temperatures at points 26 and 28.

It is often desirable to have the outer surface of tube 1 exhibit the same temperature from end 28 to end 30 and, preferably, have the temperature of the exit gas at point 32 be no higher that the temperature of furnace 34. Such an ideal condition assures uniform furnace heating and maximizes the efficiency of the heat transfer.

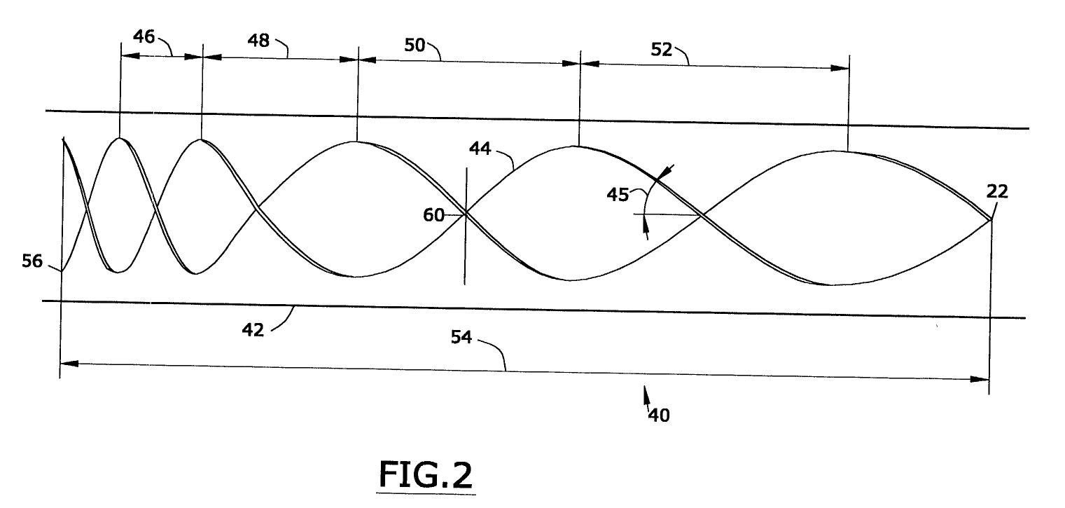

In order to approach this ideal condition, applicant has designed a series of novel radiant tube assemblies. One of these assemblies is illustrated in FIG. 2. It will be seen that radiant tube assembly 40 is comprised of a radiant tube 42 and disposed therein a variable pitch helical ceramic insert 44. As is known, pitch refers to the distance between two adjacent turns of the helices. Thus, in variable pitch insert 44, pitch 46, pitch 48, pitch 50, and pitch 52 are not necessarily all equal to each other.

Although FIG. 2 illustrates a helical insert 44 with 5 helical sections, it will be apparent that helices with fewer or more sections may be used.

The helical insert 24 will have a length such that the ratio of its length to its diameter is from about 1/1 to about 15/1, and preferably from about 2/1 to about 8/1. The diameter of helical insert 44 is from about 2 to about 10 inches.

The pitches used in helical insert 44 range from about 2 to about 32 inches; The pitch of the helical insert 44 divided by the diameter of the insert will determine the helix angle 45 (see FIG. 2). For the preferred helical insert 44 for a ceramic insert, the helix angle 45 will range from about 15 to about 80 degrees and, preferably from about 40 to about 80 degrees, and more preferably from about 60 to about 80 degrees.

When the integral metal insert is made out of molten metal alloy material, it is preferred that the helix angle be from about 50 to about 80 degrees and, preferably, from about 55 to about 80 degrees.

When the integral insert is made out of castable refractory material, it is preferred that the helix angle be from 30 to about 80 degrees.

The pitches used in helical insert 44 range from about 0.5 to about 8 inches of pitch per inch of diameter of the helical insert.

The pitch at the point 22 of the insert 44 nearest the burner (not shown) is larger than the pitch at point 56 nearest the gas exit port (not shown).

Referring again to FIG. 2, insert 44 is an integral assembly. In another embodiment, not shown, such assembly 44 could comprise two or more segments contiguous with each other. Thus, e.g., one could have such contiguity at point 60 between two separate insert segments 44. In one embodiment, not shown, two or more separate insert segments 44 are separated by a gap which, preferably, is from about 1.0 to about 3.0 segment lengths.

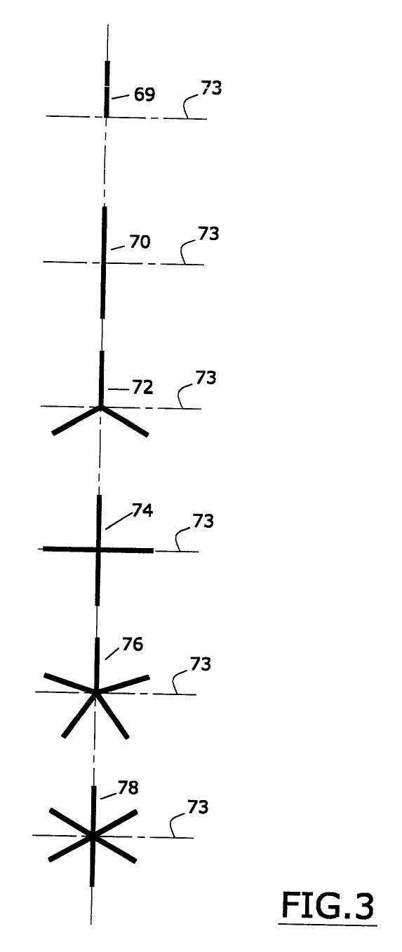

One may vary the heat dissipation properties of the radiant tube by utilizing ceramic inserts with different cross sectional shapes. Referring to FIG. 3, in which dotted lines 73 indicate the center lines of the inserts, one may use the substantially tape-like shape 69, the substantially tape-like shape 70, the three-winged cross-sectional shape 72, the four winged cross sectional shape 74, the five winged cross-sectional shape 76, and the six winged cross-sectional shape 78. The inserts made from shapes 69, 70, 72, 74, 76, and/or 78 are preferably helical along their length.

It is desirable to vary the heat transfer characteristics of the radiant tube assembly comprised of the radiant tube 10 and the insert 24 so that the temperature radiated by the assembly is substantially more uniform along its length. Without the use of a ceramic insert, the temperature within the tube 10 will vary as composition of the reaction mixture within the tube, and/or its temperature, varies. The inventions described in this specification tend to minimize such variances.

One may vary the heat transfer characteristics of the insert within the tube 10, from one point to another by means such as those illustrated in FIG. 2, wherein the pitch and pitch angle of the insert are varied from one end to another. Another means of doing so is illustrated in FIG. 3, wherein the surface area of the insert is varied. As “wings” are added to the insert, the surface area of the insert increases, and the heat transfer characteristics increase. Referring to FIG. 3, the “wing” portion is the portion denoted by a solid line extending outwardly from the center point.

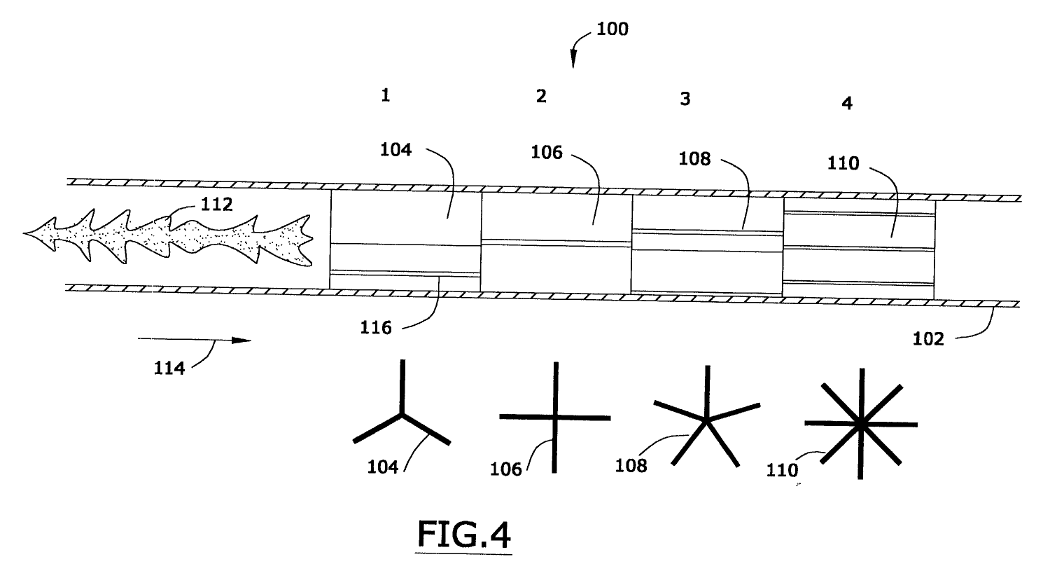

FIG. 4 illustrates an assembly 100 comprised of a radiant tube 102 in which there disposed ceramic inserts 104, 106, 108, and 110; in the embodiment depicted, tube 102 is linear.

In the embodiment depicted, ceramic insert 104 is comprised of three wings, ceramic insert 106 is comprised of four wings, ceramic insert 108 is comprised of/five wings, and ceramic insert 110 is comprised of eight wings. In this embodiment, inserts 104, 106, 108, and 110 are substantially contiguous with each other. In another embodiment, not shown, a ceramic insert with two wings is disposed in front of ceramic insert 104.

In one embodiment, not shown, in addition to the number of wing in adjacent insert sections, or instead of varying such wings, one may vary either the helix angle or pitch in adjacent sections.

Referring again to FIG. 4, the air/gas mixture 112 is combusted in a burner (not shown) and travels in the direction of arrow 114 down tube 102. At a certain point 116 the flame caused by the combustion of mixture 112 ceases to exist. The temperature of mixture 112 decreases as it travels in the direction of arrow 114.

When the air gas mixture 112 contacts insert 104, it is relatively hot; the insert 104, because it has a relatively low surface area, has a relatively low rate of heat transfer to the inner surface of tube 102.

When the air gas mixture 112 contacts insert 106, it is cooler than when it contacted insert 104; thus insert 106 is designed with a higher surface area in order to provide a higher rate of heat transfer than that provided by insert 104; the goal is, by balancing these variables, to maintain the outer surface of tube 102 at substantially the same temperature.

Another means of varying the heat transfer characteristics of the radiant tube assembly is by utilizing discontinuous insert segments, i.e., segments which are not contiguous with each other. Such an arrangement is illustrated in FIG. 1, wherein the section 120 of the tube 10 contains no ceramic insert, but the section 122 of the tube 10 does contain such an insert.

Referring again to FIG. 1, radiant tube 10 is substantially linear. In another embodiment, not shown, the radiant tube 10 will be substantially arcuate, being substantially U-shaped or W-shaped. In another embodiment, not shown, the radiant tube 10 will have both linear and arcuate portions.

In one embodiment, not shown, the radiant tube 11 has two straight legs connected to an arcuate elbow. This type of radiant tube is often referred to as a U-type tube.

By way of further illustration, one may use a W-tube with four legs and three elbows, which is also comprised of linear and arcuate sections.

It is preferred to use the ceramic insert of this invention in those portions of the radiant tubes closest to the exhaust; for, in such portions, the combustion mixture will generally be at a lower temperature than it is in the portions nearer the burner.

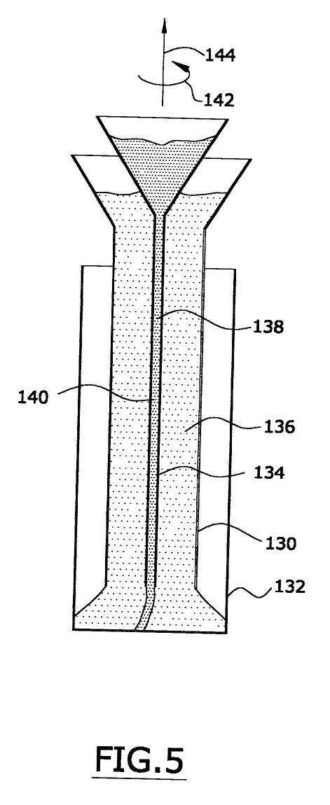

FIG. 5 is a flow diagram of one preferred process for making a ceramic insert. The process described in this flow diagram involves the use of silicon carbide grains; however, it will be apparent that the process is also useful with other ceramic materials.

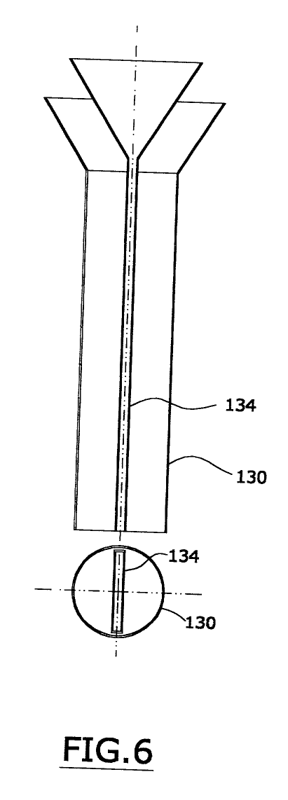

Referring to FIG. 5, a round funnel 130 is disposed within a vertical closed bottom aluminum tube 132. Thereafter, an inside flat blade forming funnel is disposed within the funnel 132. The tube 132, the funnel 130, and the funnel 134 are attached to each other by conventional means (such as screws) in order to maintain them in fixed spatial relationship vis-a-vis each other. The spatial relationship of funnels 130 and 134 is also illustrated in FIG. 6.

Funnel 130 is filled with silicon carbide grains. It is preferred that at least about 99 weight percent of the silicon carbide grains have an average particle size of from about 50 to about 1000 microns and, more preferably, of from about 150 to about 250 microns. In one embodiment, substantially all of the silicon carbide grains have an average particle size of from about 160 to about 220 microns.

For the silicon carbide grains described above, the desired particle size ranges facilitate the pourability of the powder. When other powders are used for form the ceramic material, different particle size ranges may be desirable.

The silicon carbide grains 136 are preferably poured into funnel 130 until the grains reach near the top of such funnel. Thereafter, a mixture 138 comprised of such silicon carbide grains 136 and resin are poured into fimnel 134.

A relatively small amount of such resin (from about 1.5 to about 5 weight percent, weight of dry powdered resin by total weight of resin and silicon carbide) is used. The resin is used as a binder which will afford structural integrity to the tape formed within funnel neck 140.

In one embodiment, the resin used is a dry powdered phenolic resin sold as “Durez 29-302” by the Occidental Chemical Corporation (Durez Division) of Niagara Falls, N.Y.

Once both of the funnels 130 and 134 have been filled with grains, the funnel 134/funnel 130 assembly is simultaneously rotated in the direction of arrow 142 while being pulled upwardly in the direction of arrow 144. Varying the rate of rotation for a given lift rate will vary the pitch on the helix being formed by the process.

If the funnel 134/funnel 130 assembly is lifted without being rotated, a straight extruded blade will be formed. If the funnel is lifted while being rotated in one direction and then in another direction, a tape with reversing helical portions will be formed. If a funnel 134 is used with a cross section different than the rectangular cross section depicted in FIG. 5, the helical tape formed will have such different cross section (see FIG. 3). Reference may be had to applicant's U.S. Pat. Nos. 5,655,599, 5,071,685, and 4,789,506 for a discussion of other aspects of and uses for this process.

The funnel 134/funnel 130 assembly may be turned by conventional means, such as by means of a cam follower. Inasmuch as funnels 130 and 134 are attached to each other, the twisting and raising of funnel 134 also twists and raises funnel 130. The removal of the 130/134 funnel assembly leaves the formed helical tape within a bed of loose grains of silicon carbide, both of which are disposed within container 132. Thereafter, container 132 with the helical tape therein and the loose silicon carbide is transported to an oven (not shown) where it is heated to a temperature of from about 350 to about 450 degrees Fahrenheit to set the resin particles and afford structural integrity to the helical tape.

After heating, the formed helical tape is removed from the bed of silicon carbide particles. The tape as formed is then treated to transform the resin while maintaining the structural integrity of tape.

One such transformation process involves contacting the tape with molten silicon, which infiltrates and/or wicks into the body of the tape, converts the resin to elemental carbon, and thereafter converts the elemental carbon into secondary silicon carbide. It is preferred to contact the tape with the molten silicon in a vacuum chamber or an inert gas atmosphere to prevent oxidation of the resin (which would form carbon dioxide and remove the support from the silicon carbide grains) while subjecting the tape and the silicon to a temperature of from about 1,500 to about 1,900 degrees Celsius for a period of less than about 15 minutes.

The infiltrated tape thus formed is allowed to cool. Thereafter it is ready to use in the structure depicted in FIG. 1.

The helical tape may be treated to form other silicon infiltrated materials besides the one discussed above. Thus, e.g., one could use a graphite grain, or amorphous carbon grain, rather than the silicon carbide grain.

The Metal Alloy Insert of the Invention

In one preferred embodiment, the process depicted in FIG. 5 is used to prepare a metal alloy insert. As will be apparent to those skilled in the art, this process allows one to obtain an insert with a higher degree of pitch and a more complicated shape than does the process depicted in U.S. Pat. No. 4,869,230.

Referring to FIG. 5, in order to make the metal alloy insert the process is modified in the manner described below.

Instead of filling funnel 130 with silicon carbide grains, funnel 130 is filled with resin coated foundry sand.

In order to prepare the resin-coated foundry sand, one preferably coats foundry sand. As is known to those skilled in the art, foundry sand is sand used in foundries to make molds for the casting of metal shapes. As is known to those skilled in the art, phenolic novolac have been used for many years as a sand binder with hexamethylene tetramine as a crosslinking-curing agent to form sand cores and molds for metal casting. This is accomplished by coating sand with a mixture of phenolic novolak resin and hexamethylene tetramine to produce a free flowing product consisting of individually coated grains of the sand. Reference may be had, e.g., to U.S. Pat. Nos. 3,965,962, 4,002,722, 3,934,858, 3,934,810, 3,937,272, 3,937,438, 4,713,294, and the like. The disclosure of each of these United States patents is hereby incorporated by reference into this specification.

Coating the sand has been typically accomplished by at least two different methods. In the first method, the resin can be coated onto the sand particles from a solvent solution of methanol or other suitable solvent. The solvent is then evaporated as the resin and sand are mixed at temperatures ranging from ambient to somewhat above ambient. This process is known as “warm coating”, and the hexamethylene tetramine has often been added to the resin in the form of a powder, in a mixer before the solvent has evaporated.

In the second method, solid resin can be added to hot sand, wherein it is mixed, melted and coated on the grains of sand. An aqueous solution of hexamethylene tetramine may then be added to the hot resin-sand mixture. The water evaporates and cools the sand to a point where the resin solidifies, and forms a free flowing mixture of coated sand grains.

The resin coated sand produced by either the warm coated process or the hot coating process is then placed on a hot pattern or in a hot core box to melt the resin and bond the sand grains together while the hexamethylene tetramine acts as a curing agent to cure the resin into a durable thermoset product.

The sand molds and cores formed by this process are often in the shape of a bonded sand shell that is the negative of the mold or core shape, hence the name “shell process” for this molding method and “shell sand” for the resin coated sand.

Referring again to FIG. 5, and in the preferred embodiment depicted therein, the resincoated foundry sand is preferably made by mixing foundry sand with from about 1.5 to about 5 weight percent of the resin. One may use the same resin as is used to prepare the resin-coated silicon carbide grains described elsewhere in this specification.

Once the mixture of the desired resin and foundry sand has been prepared, it is poured into funnel 130. The resin-coated foundry sand should be free flowing and, to that end, should have a particle size such that at least about 90 weight percent of its particles are within the range of from about 100 to about 500 microns.

The resin-coated foundry sand is poured into funnel to a height sufficient to prepare the desired object, and then funnel 134 is filled with foundry sand which is not resin coated. The non-resin coated foundry sand typically is within the particle size range of from about 100 to about 500 microns, and it also preferably is free flowing.

Once both of the funnels 130 and 134 have been filled with grains, the funnel 134/funnel 130 assembly is simultaneously rotated in the direction of arrow 142 while being pulled upwardly in the direction of arrow 144. Varying the rate of rotation for a given lift rate will vary the pitch on the helix being formed by the process.

If the funnel 134/funnel 130 assembly is lifted without being rotated, a straight extruded blade will be formed. If the funnel is lifted while being rotated in one direction and then in another direction, a tape with reversing helical portions will be formed. If a funnel 134 is used with a cross section different than the rectangular cross section depicted in FIG. 5, the helical tape formed will have such different cross section (see FIG. 3). Reference may be had to applicant's U.S. Pat. Nos. 5,655,599, 5,071,685, and 4,789,506 for a discussion of other aspects of and uses for this process.

The funnel 134/funnel 130 assembly may be turned by conventional means, such as by means of a cam follower. Inasmuch as funnels 130 and 134 are attached to each other, the twisting and raising of funnel 134 also twists and raises funnel 130. The removal of the 130/134 funnel assembly leaves the formed helical tape of uncoated foundry sand within a bed of resin-coated foundry sand, both of which are disposed within container 132. Thereafter, container 132 with the uncoated foundry sand helical tape therein and the resin-coated foundry sand is transported to an oven (not shown) where it is heated to a temperature of from about 350 to about 450 degrees Fahrenheit to set the resin particles and afford structural integrity to the mold formed by this process.

After heating, the formed uncoated foundry sand helical tape poured out of the set mold of resin coated foundry sand. This set mold may then be utilized to form the metal alloy inserts of this invention by conventional metal casting processes.

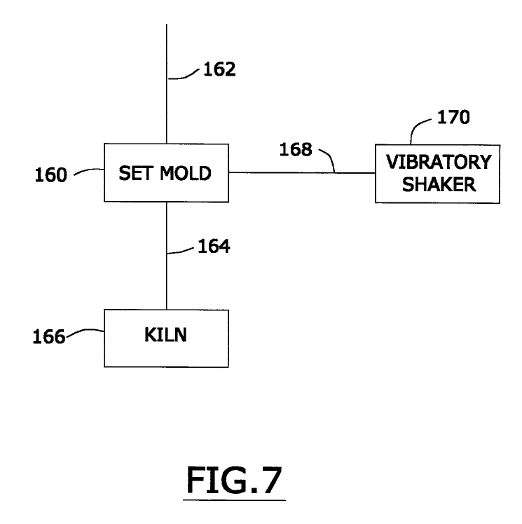

FIG. 7 is a flow diagram of a preferred process for making various cast objects using the set mold made by the process illustrated in FIG. 6.

Referring to FIG. 7, and in the preferred embodiment depicted therein, molten material is charged to set mold 160 via line 162.

In one embodiment, the molten material used is molten metal alloy. It is preferred to utilize a molten metal alloy which, upon cooling, produces an alloy material in the desired shape which has high temperature oxidation resistance, that is, when it is heated to a temperature of 2,100 degrees Fahrenheit for at least about six months, less than about 2 weight percent of the material is converted to an oxide form.

One may use metal alloys such as, e.g., nickel-chromium alloy, iron-nickel-chromium alloy, iron-aluminum alloys, nickel-aluminum alloys, and the like. Thus, by way of illustration and not limitation, one may use the commercially available alloys for high-temperature process service listed at page 23-71 of Robert H. Perry et al.'s “Chemical Engineer's Handbook, Fifth Edition (McGraw-Hill Book Company, New York, 1973). Thus, e.g., one may use austenitic steels of the 300 series, such as Types 304, 321, 347, 316, 309, 310, 330, and the like. Thus, e.g., one may use nickel-base alloys which contain nickel, Incoloy, Hastelloy B, Hastelloy C., Multimet, and the like. Thus, e.g., one may use cast irons, cast stainless (ACI types), super alloys (such as Inconel X, Stellite 25, etc.), and the like. Reference may be had, e.g., to U.S. Pat. No. 5,882,856 (heat resistant nickel based alloy), U.S. Pat. Nos. 5,866,068, 5,824,166 (intermetallic alloy), U.S. Pat. No. 5,789,089 (cast steel), U.S. Pat. Nos. 5,330,705, 5,288,228, 5,194,221, 5,077,006, and the like. The entire disclosure of each of these United States patents is hereby incorporated by reference into this specification.

The integral metal alloy insert produced by the aforementioned process is creep resistant. As used in this specification, the term “creep resistant” means that, when the insert is supporting it own weight on the longitudinal axis, in a vertical position, and when in such position it is subjected to a temperature in the range of from 1,000 degrees Fahrenheit to 2,200 degrees Fahrenheit for 8,000 hours, its longitudinal dimension will not change more than 10 percent.

The integral metal alloy insert produced by the aforementioned process also is oxidation resistant, i.e., when it is subjected to a temperature of from about 1,000 to about 2,200 degrees Fahrenheit for 8,000 hours, no more than ten weight percent of the metal alloy material is converted to an oxide form.

In one embodiment integral metal alloy insert produced by the aforementioned process has a thickness of metal alloy material of from about 0.1 to about 0.3 inches. An insert made from castable refractory materials Referring again to FIG. 7, instead of charging molten metal alloy via line 162, one may alternatively charge other heat-resistant material such as, e.g., castable refractory materials.

Castable refractory materials are well known to those skilled in the art. Reference may be had, e.g., to U.S. Pat. Nos. 6,165,926, 5,976,632, 5,932,506, 5,858,900, 5,856,251, 5,362,690, 4,762,811, 4,348,236, and the like. The disclosure of each of these United States patents is hereby incorporated by reference into this specification.

By way of further illustration, one may use one or more of the castable refractories disclosed at pages 841 to 864 of D. J. de Renzo's “Ceramic Raw Materials” (Noyes Data Corporation, Park Ridge, N.J., 1987). Thus, e.g., one may use castable refractories available the Babcok and Wilcox Company. Thus, e.g., one may use one or more of the castable refractories made by Resco Products such as, e.g., Covercast Castable, Extra Strength Castable, High Alumina Covercast, and the like.

Thus, one may use aqueous slurries containing rather coarse particles, such as hydraulic cement. Refractory concretes such as this often contain a high-alumina cement, a reactive bond, or a gelling bond. See, e.g., pages 515-516 of James S. Reed's “Principles of Ceramic Processing,” Second Edition (John Wiley & Sons, Inc., New York, 1995).

Cementious materials may be used for the castable refractory, such as portland cement, high alumina cement, ciment fondu, and the like.

When portland cement is used, it preferably contains tricalcium silicate and dicalcium silicate, and often contains minor amounts of tricalcium aluminate, brown-millerite, calcium oxide, magnesium oxide, and/or glass Aluminous cement may also be used. It contains approximately 40 percent of alumina, 40 percent of calcium oxide, 7 percent of silica, and 7 percent of ferric oxide.

Many other cementitious materials may be used; see, e.g., pages 569-573 of W. D. Kingery's “Introduction to Ceramics” (John Wiley & Sons, New York, N.Y., 1975).

Because of the relatively high viscosity nature of these aqueous slurries, the cast bodies made in the process depicted in FIG. 7 generally have a thickness of from about 0.1 to about 0.5 inches.

Referring again to FIG. 7, after either the molten metal alloy material, or the aqueous slurry of a castable refractory, has been charged via line 162 to set mold 160, the cast assembly is then processed differently, depending upon whether it contains molten metal or aqueous slurry When the cast assembly contains aqueous slurry, such as is commonly the case when one is using a castable refractory material, it is allowed to set for a period of from about 1 to about 48 hours and then conveyed via line 164 to kiln 166. In kiln 166 it is fired under air atmosphere at a temperature of above 800 degrees Centigrade, it being understood that such temperature is high enough to oxidize the resin binder used in the mold and thus force it to disintegrate. In general, the mold/cast product assembly is fired at such high temperature for from about 2 to about 8 hours.

This firing, in addition to disintegrating the foundry sand/resin bonds, dries the cast part to a moisture content of less than about 1 percent. After such firing, the fired assembly is removed from kiln 166 and allowed to air cool. Thereafter, the assembly is cleaned by removing any residual foundry sand on it, and it is then ready for use.

When the set mold is filled with molten metal, the filled assembly is allowed to cool to room temperature. Thereafter it is conveyed via line to vibratory shaker 170, wherein it is vibrated to cause the separation of the resin-coated foundry sand from the cast metal alloy object. One may use conventional shakeout procedures to effect this separation. Any casting risers may be removed by cutting.

When the set mold is filled with castable refractory, the castable refractory generally is water-based. Thus, in this embodiment, the set mold 160 should preferably be prewetted in order to prevent water from the water-based refractory being absorbed into the mold. By way of illustration, when the mold consists of the aforementioned foundry sand, the mold may be immersed in water for about 5 minutes prior to the time the castable refractory composition is charged to it.

In one embodiment, in order to fully fill the set mold when the castable referactory is being poured into it, the set mold is mechanically vibrated.

The insert produced from the castable refractory material is comprised of at least 95 weight percent of oxide material and, thus, is resistant to further oxidation, even at a temperature of from 1,000 to 3,000 degrees Fahrenheit for at least 8,000 hours.

The integral castable refractory insert produced by the aforementioned process is creep resistant. As used in this specification, the term “creep resistant” means that, when the insert is supporting it own weight on the longitudinal axis, in a vertical position, and when in such position it is subjected to a temperature in the range of from 1,000 degrees Fahrenheit to 2,200 degrees Fahrenheit for 8,000 hours, its longitudinal dimension will not change more than 10 percent.

In one embodiment, the thickness of the walls of the integral castable refractory is from about 0.1 to about 0.5 inches.

The Shape of the Metal Alloy Insert of this Invention

In one preferred embodiment, where the integral insert is an integral metal-alloy insert, the insert has a helical and contains at least three wings extending outwardly form the centerline of the helix. This shape, in combination with a helix angle of from about 50 to about 80 degrees, provides an insert with substantially superior performance characteristics.

It is to be understood that the aforementioned description is illustrative only and that changes can be made in the apparatus, in the ingredients and their proportions, and in the sequence of combinations and process steps, as well as in other aspects of the invention discussed herein, without departing from the scope of the invention as defined in the following claims.

I claim:

1. An insert for a radiant tube consisting essentially of an oxidation resistant metal alloy, wherein said insert has a helical shape with a helix angle of from about 50 to about 80 degrees, wherein said insert is comprised of a longitudinal centerline and at least three wings extending outwardly from said centerline, and wherein:
(a) when said insert is subjected to a temperature of 2,100 degrees Fahrenheit for at six months, less than about 2 weight percent of said insert converted to an oxide form,
(b) when said insert is subjected to a temperature of from about 1,000 to about 2,200 degrees Fahrenheit for 8,000 hours, less than ten weight percent of said insert is converted to an oxide form, and
(c) when said insert is disposed in a vertical position and is supporting its own weight, and when in said vertical position it is subjected to a temperature of from about from 1,000 degrees Fahrenheit to 2,200 degrees Fahrenheit for 8,000 hours, its length does not change by more than 10 percent.

2. The insert as recited in claim 1, wherein said insert consists essentially of an alloy comprised of nickel and chromium.

3. The insert as recited in claim 1, wherein said insert consists essentially of an alloy comprised of iron, nickel, and chromium.

4. The insert as recited in claim 1, wherein said insert consists essentially of an alloy comprised of iron and aluminum.

5. The insert as recited in claim 1, wherein said insert consists essentially of an alloy comprised of nickel and alumium.

6. The insert as recited in claim 1, wherein said insert is comprised of walls with a thickness of from about 0.1 to about 0.3 inches.

7. An insert for a radiant tube consisting essentially of a refractory material, wherein said insert has a helical shape with a helix angle of from about 30 to about 80 degrees, wherein:
(a) said insert is comprised of at least 95 weight percent of oxide material, and
(b) when said insert is disposed in a vertical position and is supporting its own weight, and when in said vertical position it is subjected to a temperature of from about from 1,000 degrees Fahrenheit to 2,200 degrees Fahrenheit for 8,000 hours, its length does not change by more than 10 percent.

8. The insert as recited in claim 7, wherein said insert is comprised of walls with a thickness of from about 0.1 to about 0.5 inches.

9. The insert as recited in claim 7, wherein said insert is comprised of a longitudinal centerline and at least three wings extending outwardly from said centerline.

10. The insert as recited in claim 7, wherein said castable material is comprised of a high-alumina cement.
